(19) United States
(12) Patent Application Publication
(10) Pub. No.: US 2005/0064121 A1
(43) Pub. Date: Mar. 24, 2005

(54) Manufacturing method of resin tubes used in curtain and curtains made of the same

(76) Inventors: Tsuyoshi Takami, Kurashiki-Shi (JP); Jun Okamoto, Kurashiki-Shi (JP)

Correspondence Address: Tsuyoshi Takami, 235 Chung - Ho, Box 8-24, Taipei, TW

(21) Appl. No.: 10/672,174

(22) Filed: Sep. 24, 2003

(51) Int. Cl. B32B 1/08

(52) U.S. Cl. 428/36.5; 428/36.9; 264/51

(57) ABSTRACT

A method for manufacturing resin tubes used in curtains is enclosed. The method comprising the steps of: adding polypropylene and foaming agent to an extruder for melting and blending as a mixing material, feeding the mixing material to a mould; shaping the mixing material by passing the mixing material out of a ring-shape outlet of the mould so as to form with a tube; solidifying the tube in a cooling tank; and cutting the tube into a plurality of resin tubes each having a predetermined length. Also a resin tube for weaving curtains is related. The resin tube is made of foamed polypropylene resin.

### FIELD OF THE INVENTION

The present invention is related to small resin tubes used in curtains, especially a small tube made of foamed polypropylene with natural style and curtains made of such small tubes, and also related to a manufacturing method for making the small tubes.

### BACKGROUND OF THE INVENTION

Curtains made of natural materials such as reeds, bamboos, etc. are widely used in sunshading. Up to now, the small tubes widely used in curtains are made of PVC or polypropylene, etc. for their high productivity, quality and stability, but such small tubes made of PVC, etc. have smooth and bright surfaces so as to lose of natural feelings. In the prior art, some patents disclosed manufacture methods for tubes with natural feelings, such as JK60-227714 that revealed a small curtain tube with bamboo shape made of resin and by a coupling of male & female rotating wheels. The small curtain tubes presented in JK60-227714 have bigger concave-convex portions on its bright surface without good natural feeling that is quite different compared with natural style of surface.

Package materials made of resins are also used in food package, but as mentioned above, they are not considered as high-level ones for their smooth and reflective surfaces. If natural materials are used for such purposes, their hygiene control will not be so easy.

The small tubes are easy to be produced and also extruded in its production process because of uniform shapes thereof. In other words, tubes with smooth and even surface are easy to be extruded, but if natural feeling is required, its uneven shape will certainly make its extrusion difficult. Such difficulty in extrusion process is caused by the uneven surface of the small tubes.

### SUMMARY OF THE INVENTION

The purpose of the present invention is to solve the problems mentioned above, which presents a small tube with natural feeling and its easy manufacture method.

The problems mentioned above can be solved by adopting foamed polypropylene to manufacture small resin tubes in the external diameter (d) of 2.5˜10 mm thereof and the ration to its wall thickness (t) of 0.02˜0.2 (t/d) with suitable hardness and light weigh. The appearance gravity shall be between 0.7 to 0.95 for keeping the natural appearance and suitable hardness thereof.

The resin tube of the present invention has fine longitudinal veins and irregular textured lines to make it have natural style and not to be easily drawn out from a finished curtain.

The manufacture method of small resin tube in the present invention comprises the steps of putting polypropylene resin and foaming agent into extruder for dissolving and blending firstly, then extruding out from mould at outlet with ring shape; leading the extruded semi-product into cooling tank for cooling and solidifying, then cutting the tube at wanted length to give the finished tube with natural style in high effectively.

The foaming agent in the raw material mentioned above is 0.5˜0.5% in weight for giving natural appearance and suitable hardness and extruding speed of the agent is between 10˜100 m/minute. A ratio of diameter (D) of mould outlet mentioned above to external diameter (d) of the small resin tube (d/D) is between 0.2 to 0.8. These two methods are most suitable to manufacture small resin tubes with natural style.

In addition, the small resin tube of the present invention is suitable to be used in weaving curtains for sun-shading and vision-shading, or food package and etc.

The present invention is related to the small resin tubes made of foamed polypropylene, and preferably, the resin is selected from solely polypropylene. However, other resins are also suitable in the present invention, which is not used to confine the scope and spirit of the present invention the present invention. The polypropylene is able to combine with varied additives.

Foaming agent is one of the additives being a component in the raw materials. There is no specified requirement for such foaming agents. Any of volatile foaming agents with the boiling point below the melting-forming temperatures thereof are suitable in the present invention. The foaming agent capable of decomposing into gas at high temperature is also suitable in the present invention. This kind of forming agent is especially suited for a process machine with simple blending device. The foaming agent occupies a weight percentage of 0.05 to 0.5 in raw materials. Preferably, the weight percentage is more than 0.1 weight % for it's the lowest limitation because the tube surface will be smooth if foaming agent content is less than that limitation. But if its content is too high, the foaming of resin will be heavy, tube strength will be weak with its wall broken easily, and so the content of foaming agent shall be less than 0.3 weight % for its higher limitation.

Reeds, bamboos and wood have their natural color. This artificial tube can be painted with color like its natural one to make it nature-likes. In addition, the color is also used for improving the performance for sun shading and secret-hiding. The pigment and its quantity should be adjusted suitably according to the purpose.

In addition, inorganic filler can be added, such as calcium carbonate, mica power and etc., for improving the secret-hiding property and increasing the surface friction coefficient thereof. Preferably, calcium carbonate is used as a filler because it is cheap, more preferably, 20˜30 weight % of calcium carbonate is added in the raw material.

For sun shading, especially avoiding directly radiation of sunlight a preferred way is to add ultraviolet absorber in the material of the resin tube to make curtain more durable. However, the present invention is not confined by this application.

Raw materials shall be blended firstly and then put into an extruder. After the raw materials mentioned above are melted, it is ready to prepare the small resin tube of the present invention. Generally, extruder is used to manufacture continuous small tubes. For stable quality, all raw materials are put into a mixer for blending. When polypropylene grains and foaming agent powders are adopted, the powders shall be covered on a grain surface uniformly. It will be much better if stirring oil is used. For more uniformly foaming, ten minutes of stirring is necessary.

Alternatively, the raw materials could be put into the extruder for melting-blending firstly and then extruding therein, then the material being cooling and cutting.

Melting temperature should be over than melting point of polypropylene, and temperature rising caused by cutting should is also taken into consideration. For suitably foaming the material, it should to take attention to temperature setting of the cylinder of the extruder. Mould is used to form small tubes and the mould center should be blown to keep the shapes of the small tubes. The shape of ring outlet is not restricted. For columnar product, ring outlet is the best. The ratio of an outlet diameter (D) of the mould to an external diameter (4) of small tube is between 0.2˜0.8. At this condition, the plurality of veins are longitudinally arranged on the tube surface when this ration is smaller. Ration of 0.3˜0.5 is recommended.

The melted resin extruded is solidified via cooling tank. The cooling tank is not restricted, but a preferred one is a water cooled tank. Rollers are preferred tools for taking out the small tubes with a speed of between 10˜100 meters per minute, preferably, the spped being between 30˜70 meters/minute. However when the speed is over 100 m/minute, the resin tubes will break.

The small tube extruded is cut in certain length, usually 100˜300 cm, then cut according to application purpose. The length of small tube is decided by purpose, 30˜270 cm for sun shading, sun prevention of indoor decoration and 5˜40 cm for food package.

External diameter is 2.5˜10 mm, the best one is 3˜6 mm. Ratio of its external diameter (d) to tube wall thickness (t) is 0.02˜0.2, for sufficient hardness and light weight, its best one is 0.1˜0.04.

Appearance gravity is 0.7˜0.95. The gravity of Polypropylene is 0.9 and it can present natural appearance and suitable hardness. The gravity without foaming is about 1 if suitable amount of inorganic filler is added. The gravity of small foamed tube gravity of the present invention is smaller than that not foamed, so the small tube with it's a gravity of 0.7˜0.95 is prepared and foaming ration (air volume content) can be calculated according to the gravity difference between the formed and non-formed small tubes. By this way the foaming ratio of below 30% is calculated, preferably, the ratio being 20%, while a forming ratio of over 30% will make the hardness of the tube lower and possibly deform. Foaming ratio of over 2% is preferable and over 5% much better. If the forming ratio is less than 2%, the textures on surface will disappear.

There are small longitudinal veins on the surface of the small resin tube of the present invention, which make the surface of small tube like a natural one. There are five veins with a width of 1 mm in total. In addition, the surface shall have irregular concave-convex portions in order to reduce the brightness of the surface so as to have a beautiful appearance and to fix it tightly in final products.

The small resin tube prepared in such way is used as weft to weave curtains with warp of cotton wire, or artificial wire made of cotton and polyester, etc. Both ends, the upper end and lower end, of the warp are coated with adhesive to prevent the small resin tube from dropping. If used in package of “fish plate”, it is adhered by glue and unnecessary to weave. If the small resin tube of the present invention is selected, it can be also used in the package mentioned above with same visual results.

If it is used in curtain, it will be more suitable for indoor decoration besides for sun-shading and visual hiding. Generally, it is 30˜270 cm in width and 40˜280 cm in length with plastic rails at both sides, upper and down. The curtain of the present invention can form soft climate that is benefit to eyes, besides its functions of suitable air circulation and light adjustment. So it is also suitable for the applications in decoration of shop or advertisement to improve IC of the shop or its merchandise.

In addition, for the purposes of food package, the plastic rail is not added at both sides, the upper end and lower end. Only the small resin tubes are used. Generally, it is 5˜40 cm in width and 10˜60 cm in length, which can package fishplate, Japanese sweet and gift, and also can be used for other goods.

The various objects and advantages of the present invention will be more readily understood from the following detailed description when read in conjunction with the appended drawing.

### BRIEF DESCRIPTION OF THE DRAWINGS

FIG. 1 is an enlarged sectional view showing the cross section of the small resin tube of the present invention.

FIG. 2 is an enlarged structure view showing a longitudinal surface on the small resin tube of the present invention.

FIG. 3 is an application of the present invention, where the structure of the present invention is illustrated the present invention

FIG. 4 shows the flow diagram of the present invention.

### DESTRIPTION OF THE PREFERRED EMBODIMENTS OF THE PRESENT INVENTION

The following materials are put into a stirrer to blend through 70 minutes, and then put into an extruder
Polypropylene: 75 kg;
Polypropylene containing calcium carbonate: 25 kg;
Foaming agent: 220 g;
Polypropylene grains containing pigment: 1.4 kg (brown in color);
Polypropylene grains containing ultraviolet absorber: 2 kg;
Blended oil: 30 ml.

The extruder is a single shaft extruder with a screw diameter of 45 mm and a shaft length of 1010 mm. The shaft temperature setting of the extruder is divided into 4 sections from a point near feeder funnel, that is, 140° C., 150° C., 166° C., and 160° C. The shape of mould's mouth has an: external diameter D of 11.1 mm and an internal diameter of 7.6 mm. From the small hole at the center of the mould, air is blown into the mould and the melted resin is extruded from the mould from the front end of the extruder. After the extruded resin has a length of about 10 cm, it is immerged into water for solidifying in a water tank with length of about 2 m. Then the small resin tube passes through a rolling wheel and is drawn with a speed of 47 m/minute, and then is cut into sections with each having a length of 186 cm. By this way, 25 pieces of the tubes are produced in one minute.

The produced small resin tube has an external diameter d of 4.3 mm, an internal diameter 3.7 mm, a tube wall t of 0.3 mm and the ratios of t/d is 0.07, d/D being 0.39. Its gravity can be calculated by putting a section of 30 cm length of the tube into water longitudinally, and then dividing the length immerged in water by its whole length. For more accurately description, 20 pieces of tubes are tested, the average gravity of 16 pieces is 0.84 after deleting 2 pieces of the largest gravity and 2 pieces of the smallest gravity. From the following example of gravity, it can be known that small tube not foamed has a gravity of 1.00, and foaming rate (including air volume ratio) can be calculated based on the difference. It is 16% in this embodiment.

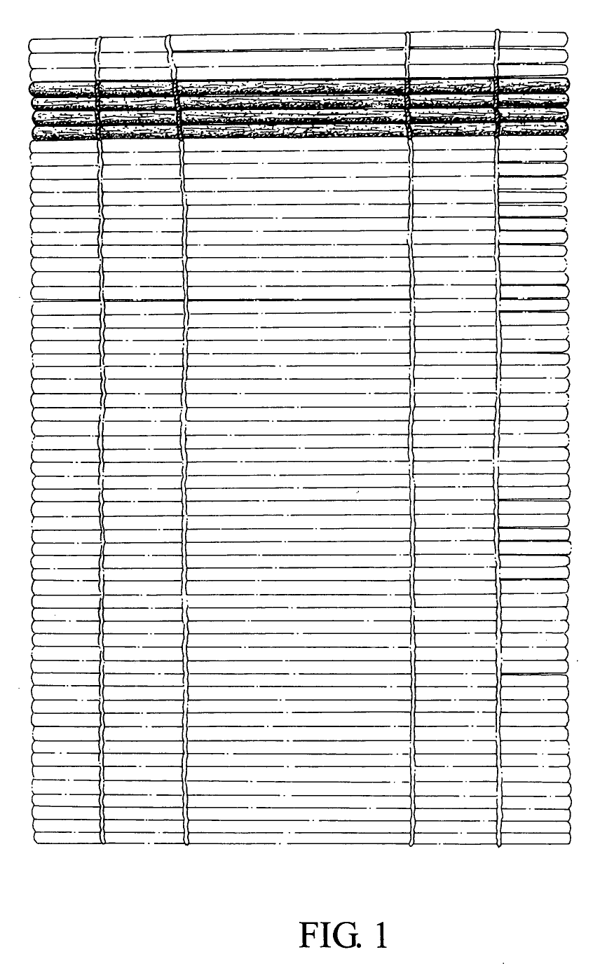

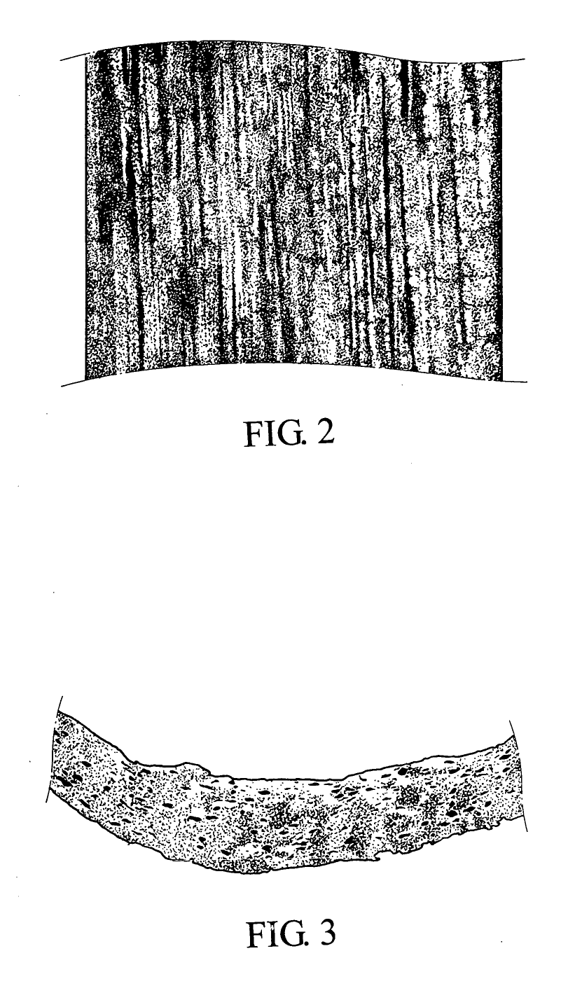

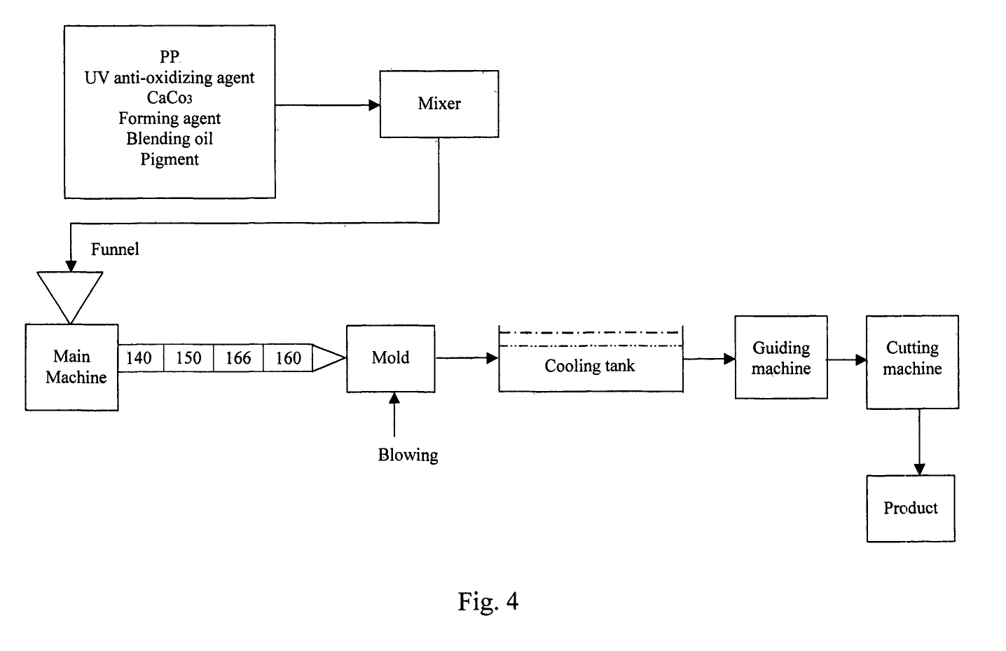

Referring to FIGS. 1 and 2, FIG. 1 is the sectional view of the small resin tube 1 cut longitudinally. FIG. 2 shows veins on a surface of small resin tube. Brightness of surface on small resin tube 1 has be reduced suitably to make it non-reflective and to have a natural appearance. Morevoer, to make surface having irregular inhomogeneous textures formed by nature-like fine veins 2. Many veins are formed along with the small tube. In addition, there are also irregular wave-like concave and convex portions with gaps therebetween being larger than those between veins. There are also fine bubbles 3 on the wall of the tube.

With reference to FIG. 3, the small resin tube of the present invention is used as wefts to weave curtains with black cotton wires as warps with intervals between 10 cm to 3 cm space with 32 kinds of different configurations. The small resin tube is clipped with two warps that are turned with 180° C. Then, another tube is added. This process is repeated to weave up to a length of 170 cm, applying gel at the cut portion and then cutting the undesired portion to prevent it from losing. The produced curtain is cut along a center line thereof into two equal parts, which then is cut respectively at two sides to obtain two sheets of curtains with a with of 88 cm, a height of 170 cmm height and 16 warps. The curtains are equipped with two plastic rails, at upper ends and lower ends, to obtain finished curtains for sun shading.

Other than natural material-like structure, the curtain of the present invention has many advantages, such as light weight, difficult to deform, high secret-shading, sun-shining prevention and difficult to pull out the small resin tubes with a small force if the curtain is cut at the middle part between warps 5 and 6. The small resin tubes fixed with 16 warps is impossible to be pulled out, even these warps are loose due to long period of use under such status it is also difficult to be pulled out.

The small resin tube of the present invention can be used to manufacture curtains with natural style with reduced brightness. The curtain is made of small resin tubes, so the mass of the curtain is homogeneous distributed. The small resin tube is difficult to be pulled out and it is durable. It is more durable in outdoor application if compared with that made of natural materials, and it is easy for hygiene administration if it is used in the area of food package.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A resin tube for weaving curtains; the resin tube being made of foamed polypropylene resin.

2. The resin tube as claimed in claim 1, wherein an external diameter of the resin tube is ranged from 2.5 mm to 10 mm, and a ratio of a wall thickness of the resin tube to the external diameter of the small tube for curtain is between 0.02 and 0.2.

3. The resin tube as claimed in claims 1, wherein an appearance gravity of the resin tube is between 0.7 and 0.95.

4. The resin tube as claimed in claims 2, wherein an appearance gravity of the resin tube is between 0.1 and 0.95.

5. The resin tube as claimed in claim 1, wherein longitudinal fine veins and irregular concave convex veins are formed on a surface of the small tube.

6. The resin tube as claimed in claim 2, wherein longitudinal fine veins and irregular concave-convex veins are formed on a surface of the small tube.

7. The resin tube as claimed in claim 3, wherein longitudinal fine veins and irregular concave-convex veins are formed on a surface of the small tube.

8. The resin tube as claimed in claim 1, wherein the small resin tube is used to weave curtains.

9. The resin tube as claimed in claim 2, wherein the small resin tube is used to weave curtains.

10. The resin tube as claimed in claim 3, wherein the small resin tube is used to weave curtains.

11. The resin tube as claimed in claim 5, wherein the small resin tube is used to weave curtains.

12. The resin tube as claimed in claim 7, wherein the small resin tube is used to weave curtains.

13. A method for manufacturing resin tubes used in curtains, the method comprising the steps of:
adding polypropylene and foaming agent to an extruder for melting and blending as a mixing material,
feeding the mixing material to a mould;
shaping the mixing material by passing the mixing material out of a ring-shape outlet of the mould so as to form with a tube;
solidifying the tube in a cooling tank; and
cutting the tube into a plurality of resin tubes each having a predetermined length.

14. The method as claimed in claim 8, wherein the foaming agent is 0.05˜0.5 weight % of the polypropylene and foaming agent.

15. The method as claimed in claim 8, wherein an extrusion speed of the resin tube is between 10 meter/minute to 100 meter/minute.

16. The method as claimed in claim 9, wherein an extrusion speed of the resin tube is between 10 meter/minute to 100 meter/minute.

17. The method as claimed in claim 11, wherein a ratio of an external diameter of the small tube to external diameter of the mould mouth is between 0.2 and 0.8.

18. The method as claimed in claim 8, wherein a ratio of an external diameter of the small tube to an external diameter of the mould mouth is between 0.2 and 0.8.

19. The method as claimed in claim 8, wherein in shaping step, veins are formed on a surface of the tube.
